(19) United States
(12) Patent Application Publication
(10) Pub. No.: US 2016/0280533 A1
(43) Pub. Date: Sep. 29, 2016

(54) COVER STRUCTURE, PANEL BODY, AND PANEL BODY MANUFACTURING METHOD

(71) Applicant: OKAMURA CORPORATION, Kanagawa (JP)

(72) Inventors: Waku TSUCHIYAMA, Yokohama-shi (JP); Haruhiko KITAJIMA, Yokohama-shi (JP); Masayuki KUROE, Yokohama-shi (JP)

(21) Appl. No.: 15/032,600

(22) PCT Filed: Oct. 31, 2014
(86) PCT No.: PCT/JP2014/079079

§ 371 Date: Apr. 27, 2016

(30) Foreign Application Priority Data
Nov. 1, 2013 (JP) 2013-228255

(51) Int. Cl. B68G 13/00; E04B 2/74; B68G 7/05; A47C 7/40; B68G 11/00; B68G 5/00

(52) U.S. Cl. CPC B68G 13/00; B68G 11/00; B68G 5/00; B68G 7/05; A47C 7/40; E04B 2/7405; E04B 2002/7487; E04B 2002/749

(57) ABSTRACT

A panel body (11) includes: an elastic cushion material (13) which is provided at at least a part of a surface of a panel base material (12), and forms an uneven shape having an angle portion (16v) on the surface of the panel base material (12); and a cover material (14) which elastically deforms the angle portion (16v) in the direction of compression, and covers the cushion material (13) and the panel base material (12).

### TECHNICAL FIELD

The present invention relates to a cover structure of furniture or the like, a panel body, and a panel body manufacturing method.

### BACKGROUND ART

In a space of an office, public facilities, or commercial facilities, a degree of freedom in using the space can be increased by dividing a part of a large space formed in the facilities into small spaces. In the space, partition equipment (partition) is widely installed. It is possible to block others' attention or sound from the periphery by installing the partition equipment.

It is possible to partition a part of the space by the partition equipment, to provide a space unique to a worker, or to provide a space for a meeting or the like.

As disclosed in Patent Document 1 and Patent Document 2, such a partition equipment includes a core material, a cover material provided on a surface of the core material, and a frame provided along an outer circumferential portion of the core material and the cover material. The partition equipment is provided to be free-standing on a floor surface or to be fixed to a all of a work space or a piece of furniture such as a desk.

However, in order to improve design, there is a case where unevenness is formed on a surface of a panel body which forms the partition equipment.

In forming the unevenness on the panel body, a method of filling a mold with a foamable resin or the like in a state where the cover material is disposed on an inner circumferential surface of the mold is generally employed. Accordingly, the cover material is pressed against the inner circumferential surface of the mold due to pressure of the foamed resin, and the unevenness formed on the inner circumferential surface of the mold is transferred to the surface of the panel body.

### CITATION LIST

### Patent Document

[Patent Document 1] Japanese Patent Publication No. 3000252

[Patent Document 2] Japanese Unexamined Patent Application, First Publication No. H 9-177209

### SUMMARY OF INVENTION

### Technical Problem

However, in the panel body forming method in which the mold is used, making the mold is expensive. In particular, making the mold which forms a large size, such as a partition equipment is expensive.

In a case where the unevenness is formed on the panel body, there is a case where the cover material is loosened due to deterioration of the foamable resin which fills the inside as time elapses. Then, the design of the panel body is damaged.

An object of the present invention is to provide a cover structure, a panel body, and a panel body manufacturing method, which can provide a panel body having excellent design at a low cost.

### Solution to Problem

In a first aspect of the present invention, a cover structure includes: an elastic cushion material which is provided at at least a part of a surface of a base material, and forms an uneven shape having an angle portion on the surface of the base material; and a cover material which elastically deforms the angle portion in the direction of compression, and covers the cushion material and the base material, in which at least one type of a through hole, a recessed portion, and a projected portion which have the angle portion on a circumferential edge is formed in the cushion material.

According to the first aspect of the present invention, by providing the cover material along the uneven shape formed on the surface of the base material by the cushion material, an uneven portion is formed at a part covered by the cover material. Accordingly, a mold for filling the inside with a foamable resin or the like and forming the resin into the shape of the panel body is not necessary.

In the formed uneven portion, an angle portion of the cushion material is elastically deformed in the direction of compression due to the cover material. Due to this, the formed uneven portion is pressed outward by a repulsive force of the cushion material at a part where the cover material abuts against the angle portion. Therefore, it is possible to maintain the shape of the uneven portion, and to prevent the cover material from stretching and becoming loose.

By forming at least one type of the through hole, the recessed portion, and the projected portion in the cushion material, it is possible to easily form the uneven shape on the surface of the base material. Additionally, by appropriately selecting and forming the through hole, the recessed portion, and the projected portion in the cushion material, it is possible to realize various uneven shapes.

In a second aspect of the present invention, in accordance with the above-described first aspect, the through hole which has the angle portion on the circumferential edge is formed, and the uneven shape is formed by the through hole, in the cushion material, and the cover material is directly adhered to the surface of the base material through the through hole.

According to the second aspect of the present invention, the uneven portion formed at a part covered by the cover material becomes a large step in accordance with the thickness of the cushion material and the design is improved.

In addition, there is a case where the cushion material is formed of a sponge-like porous material or the like. In this case, since the cover material is directly adhered to the surface of the base material on the inner side of the through hole, the cover material and the cushion material are adhered so as to form a surface. Therefore, compared to a part where the cover material is adhered to the cushion material, the cover material is firmly adhered. Accordingly, it is possible to prevent the cover material from being peeled as time elapses, and to stably maintain the shape over a long period of time.

In a third aspect of the present invention, in accordance with the above-described first or second aspect, the cover material is formed of an elastically deformable material, and covers the cushion material and the base material in a stretched state.

According to the third aspect of the present invention, the cover material stretches, and the design is improved.

In a fourth aspect of the present invention, a panel-shaped base material, in which the cover structure according to any one of the above-described aspects 1 to 3 is formed, is provided.

According to the fourth aspect of the present invention, by providing the cover material along the uneven shape formed on the surface of the base material by the cushion material, the uneven portion is formed at the part covered by the cover material. Accordingly, the design of the panel body is improved.

In addition, the angle portion of the cushion material is elastically deformed in the direction of compression due to the cover material. Therefore, the formed uneven portion is pressed outward by the repulsive force of the cushion material at the part where the cover material abuts against the angle portion. Due to this, it is possible to maintain the shape of the uneven portion, and to prevent the cover material from stretching and becoming loose.

In a fifth aspect of the present invention, in accordance with the above-described fourth aspect, the base material includes a core material of a honeycomb structure which has multiple holes which penetrate the base material in the thickness direction, and a sheet material which is provided along both surfaces of the core material.

According to the fifth aspect of the present invention, a base material which is sufficiently strong while being light in weight can be obtained.

In a sixth aspect of the present invention, a panel body manufacturing method of the panel body described in the above-described fourth or fifth aspect includes: a process of pasting the cushion material onto a surface of the base material; a process of disposing the cover material to cover the base material and the cushion material; and a process of matching the cover material to the uneven shape by pressing the cover material against the cushion material, and elastically deforming the angle portion of the cushion material in the direction of compression by the cover material.

According to the sixth aspect of the present invention, it is possible to manufacture the above-described panel body.

### Advantageous Effects of Invention

According to the present invention, it is possible to provide a panel body which has excellent design at a low cost.

### BRIEF DESCRIPTION OF DRAWINGS

FIG. 1 is a perspective view showing an example of a partition equipment which is configured by using a cover structure and a panel body in the embodiment.

FIG. 2 is a perspective developed vim showing a configuration of the panel body.

FIG. 3 is a half-sectional view in an intermediate portion in the board thickness direction of the panel body.

FIG. 4 is a top view showing an end portion of the panel body.

FIG. 5 is a sectional view showing a structure of a straight line portion of the panel body.

FIG. 6 is a sectional view showing a structure of a corner portion of the panel body.

FIG. 7A is a sectional view of a cushion material in a state where a cover material is not mounted, in a sectional view showing the cushion material provided along a surface of a panel base material.

FIG. 7B is a sectional view of the cushion material in a state where the cover material is mounted, in the sectional view showing the cushion material provided along a surface of a panel base material.

FIG. 8 is a perspective view showing a support leg body provided in an angle portion of a lower portion of the panel body, and an example of a linking structure in the lower portion of the panel bodies which are adjacent to each other.

FIG. 9 is a sectional view showing a linking structure in the lower portion of the panel bodies which are adjacent to each other.

FIG. 10 is a perspective view showing an example of the linking structure in an upper portion of the panel bodies which are adjacent to each other.

FIG. 11A is a sectional view in a state where the panel base material is assembled, in a view showing a flow of a panel body manufacturing method.

FIG. 11B is a sectional view in a state where the cushion material is provided on the surface of the panel base material, in the view showing the flow of the panel body manufacturing method.

FIG. 11C is a sectional view in a state where the cover material matches the surface of the cushion material, in the view showing the flow of the panel body manufacturing method.

FIG. 12A is an example in which a recessed portion is formed in the cushion material, in a sectional view showing a plurality of modification examples of uneven shapes in the embodiment.

FIG. 12B is an example in which a projected portion is formed in the cushion material, in the sectional view showing the plurality of modification examples of uneven shapes in the embodiment.

FIG. 12C is an example in which a step portion is formed in the cushion material, in the sectional view showing the plurality of modification examples of uneven shapes in the embodiment.

FIG. 12D is a view showing an example in which the uneven shape is a curved shape, in the sectional view showing the plurality of modification examples of uneven shapes in the embodiment.

FIG. 13 is a view showing a modification example of the cover structure and the panel body in the embodiment, and is a sectional view showing an example in which the uneven shape is formed only on one surface side of the base material.

### DESCRIPTION OF EMBODIMENTS

Hereinafter, embodiments for realizing a cover structure, a panel body, a panel body manufacturing method according to the present invention will be described with reference to the attached drawings. However, the present invention is not limited to the embodiments.

(Partition Equipment)

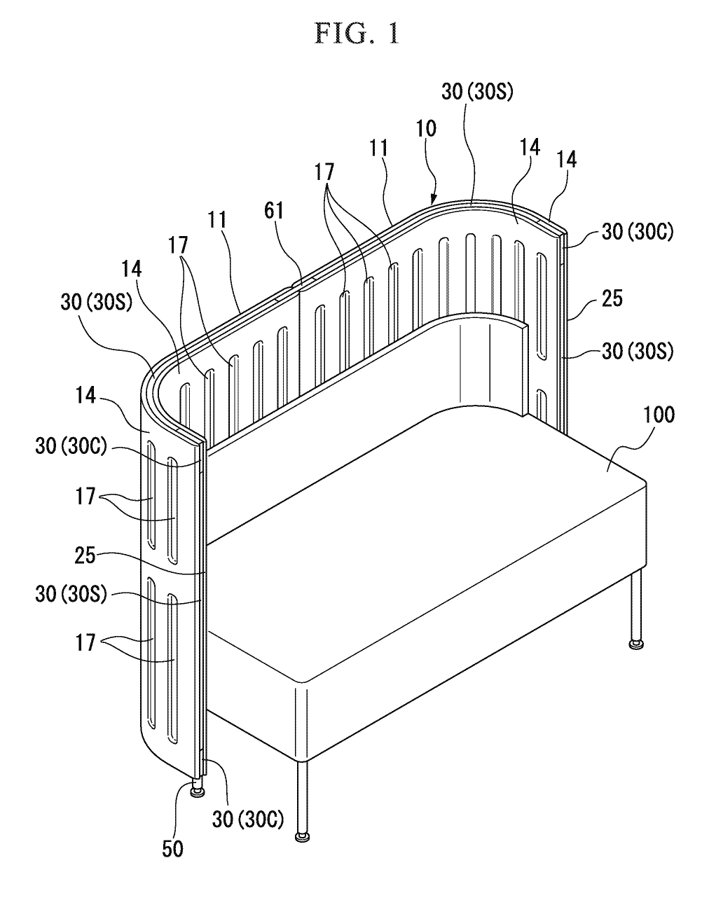

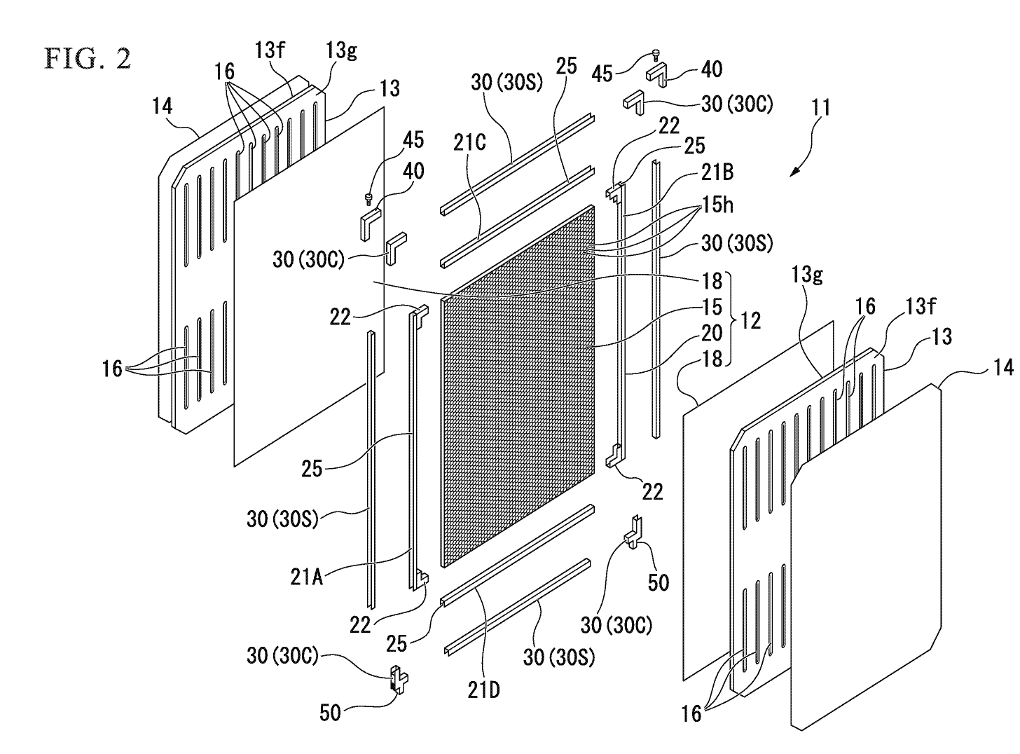

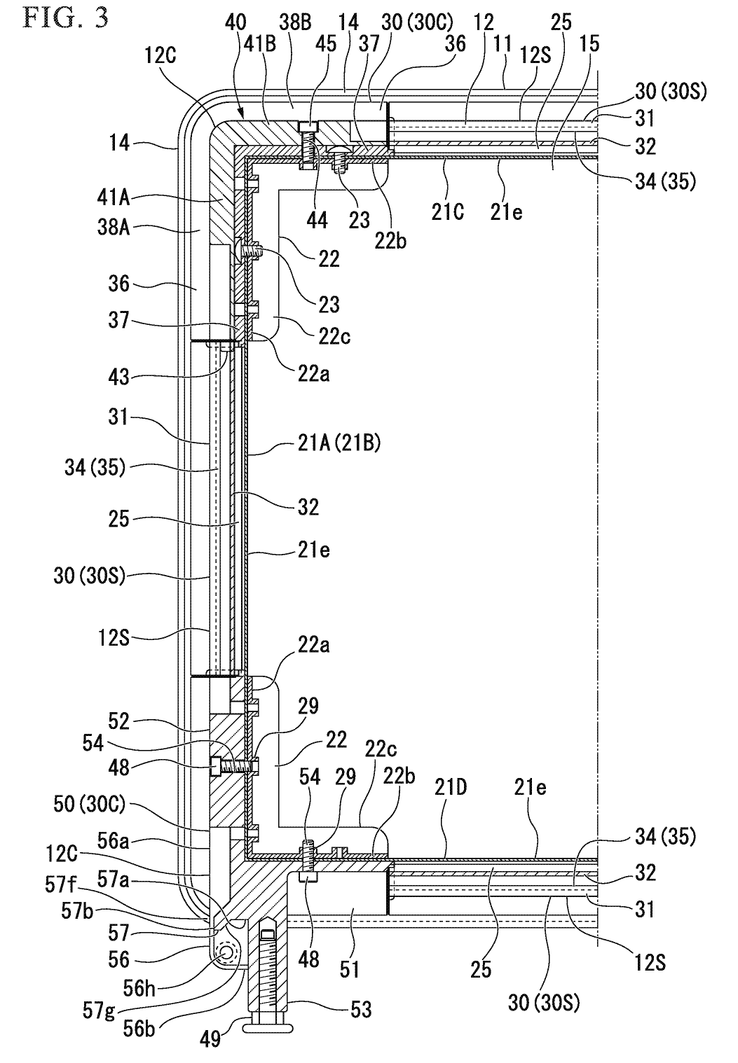

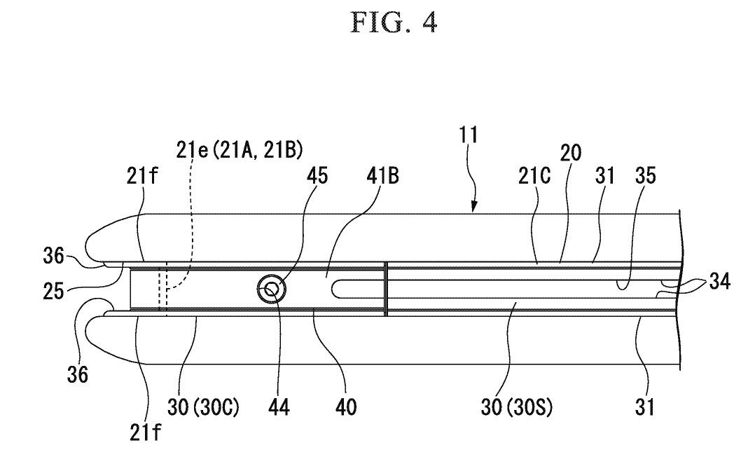

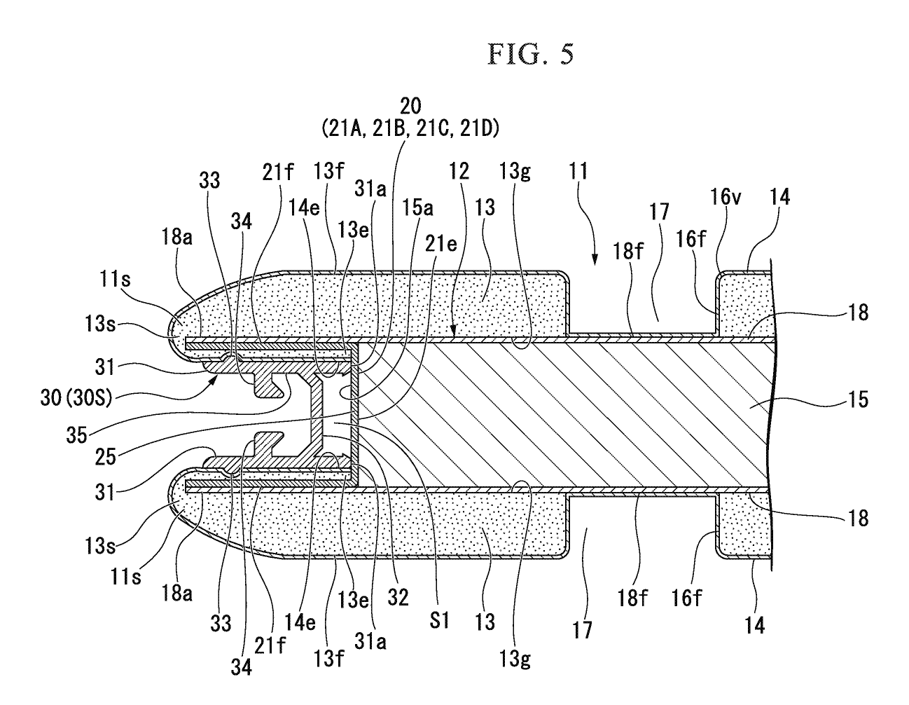

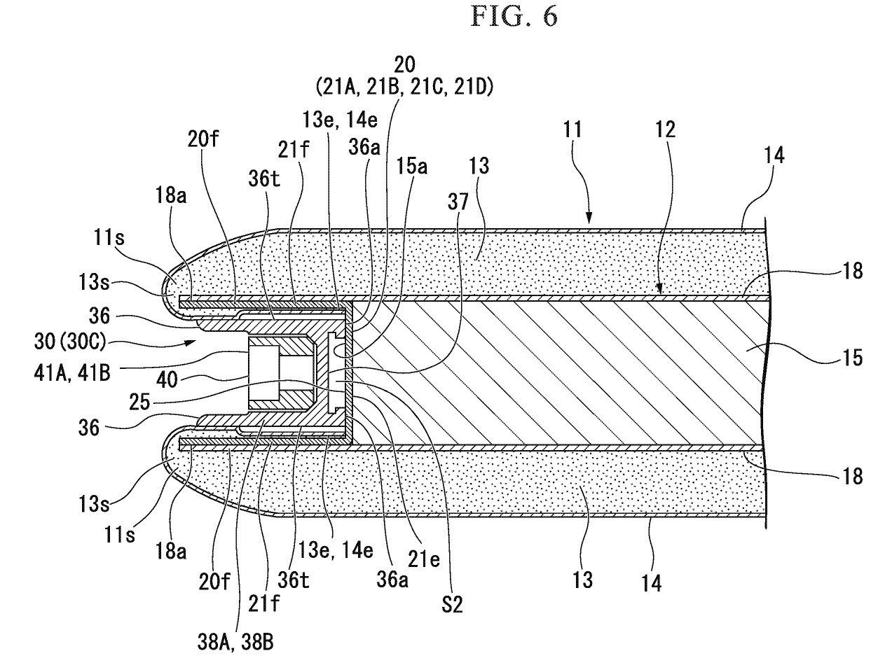

FIG. 1 is a perspective view showing an example of a partition equipment which is configured by using a cover structure and a panel body in the embodiment. FIG. 2 is a perspective developed view showing a configuration of the panel body having a shape of a flat plate. FIG. 3 is a half-sectional view in an intermediate portion in the board thickness direction of the panel body. FIG. 4 is a top view showing an end portion of the panel body. FIG. 5 is a sectional view showing a structure of a straight line portion of the panel body. FIG. 6 is a sectional view showing a structure of a corner portion of the panel body.

As shown in FIG. 1, a partition equipment 10 is configured of one or more panel bodies 11, and two panel bodies 11 in the embodiment. In the embodiment, the partition equipment 10 is installed on a rear surface side of a sofa 100. The partition equipment 10 is installed on a floor surface by a support leg body 50, and is attached and fixed to the sofa 100 by a bracket or the like which is not shown.

(Panel Body)

The panel body 11 can have a shape of a flat plate, a substantial L shape which is bent or curved in the intermediate portion when viewed in a plan view or a side view, or a substantial C shape which is entirely curved in a plan view, along a shape or the like of installed furniture. Hereinafter, the panel body 11 which has a shape of a flat plate will be described.

As shown in FIG. 2, the panel body 11 includes a panel base material (base material) 12, a cushion material 13 which is provided along both surfaces of the panel base material 12, and a cover material 14 which covers the panel base material 12 and the cushion material 13, and a fixing member 30.

(Panel Base Material)

The panel base material 13 includes a panel-like core material 15, a frame 20 which is provided along an outer circumferential portion of the core material 15, and a base sheet (sheet material) 18 which is provided to cover the core material 15 and both surfaces of the frame 20.

The core material 15 is formed of, for example, a paper-based material, a resin-based material, or a wooden material. It is preferable that the core material 15 is as light as possible. Here, in the embodiment, the core material 15 is formed of a paper-based material, and has a honeycomb structure in which multiple holes 15h which penetrate in the board thickness direction are aligned, for example, the plurality of holes 15h having a hexagonal section are combined in zigzags.

(Frame)

As shown in FIGS. 2 and 3, the frame 20 is provided in the outer circumferential portion of the core material 15. The frame 20 includes frame materials 21A, 21B, 21C, and 21D which are provided along four sides of the core material 15. Each of the frame materials 21A, 21B, 21C, and 21D is formed of a metal-based material or a resin-based material.

The frame materials 21A and 21B extend in a vertical direction along two sides which oppose each other in the core material 15, and are provided on both sides in the width direction of the panel body 11. The frame materials 21C and 21D extend in a horizontal direction being orthogonal to the frame materials 21A and 21B, and are provided on both sides of the panel body 11 in the vertical direction. The frame materials 21A and 21B and the frame materials 21C and 21D are bonded by a bolt 23, or by welding or adhering, via an L-shaped bracket 22. The frame 20 of which the entire shape is rectangular is formed by the frame materials 21A, 21B, 21C, and 21D.

As illustrated in FIGS. 4 to 6, each of the frame materials 21A, 21B, 21C, and 21D is formed to have a substantially U-shaped section which is configured of a base portion 21e which opposes an outer circumferential end surface 15a of the core material 15 on an inner circumferential side of the frame 20, and side wall portions 21f which respectively stand toward the outer circumferential side of the frame 20 from both sides of the base portion 21e in the width direction. Accordingly, a part which is surrounded by the base portion 21e and the side wall portions 21f and 21f on both sides is a groove 25.

In this manner, the panel base material 12 is continuous along the outer circumferential end portion, and has the groove 25 which is recessed to the inside of the panel base material 12.

As shown in FIG. 3, in the L-shaped bracket 22, a first plate portion 22a which is provided in the end portion of the frame material 21A or 21B along the frame material 21A or 21B, a second plate portion 22b which is orthogonal to the first plate portion 22a, and is provided in the end portion of the frame material 21C or 21D along the frame material 21C or 21D, and a rib portion 22c which is provided on the inner side of the L-shaped bracket 22 in the bending direction along the first plate portion 22a and the second plate portion 22b, are integrally formed.

The rib portion 22c is formed to protrude toward the inner circumferential side of the panel body 11 from the first plate portion 22a and the second plate portion 22b, being orthogonal to the first plate portion 22a and the second plate portion 22b. The rib portions 22c are respectively formed on both sides of the first plate portion 22a and the second plate portion 22b in the width direction, that is, on one surface side and on the other surface side of the panel body 11.

The rib portion 22c can function not only as a reinforcing member which enhances bending strength of the first plate portion 22a and the second plate portion 22b, but also as a pressing member of an angle portion of the core material 15. In other words, the core material 15 is nipped between the rib portions 22c which are respectively provided on one surface side and on the other surface side of the panel base material 12. In the panel base material 12, since the bracket 22 is provided at four corners, it is possible to hold the core material 15 on the inner side of the frame 20.

In FIG. 2, an example of the panel body 11 having a shape of a flat plate is shown, but in a case where the panel body 11 has a substantial L shape or a substantial C shape or the like when viewed in a plan view or in a side view, the upper and lower frame materials 21C and 21D or the left and right frame materials 21A and 21B of the frame 20 are bent or curved in accordance with the shape of the panel body 11.

As shown in FIGS. 5 and 6, the sheet-like base sheet 18 is provided on both surfaces of the core material 15 to cover the frame 20 and the core material 15. The base sheet 18 is formed of cardboard or the like. An outer dimension of the base sheet 18 is greater than that of the core material 15, and an outer circumferential portion 18a is adhered to a surface 20f of the frame 20 by an adhesive or the like.

(Cushion Material)

The cushion material 13 is provided along the base sheet 18 which forms the surface of the panel base material 12. The cushion material 13 is provided to cover the entire core material 15 via the base sheet 18. Furthermore, in the cushion material 13, an outer circumferential end portion 13s provided to cover the side wall portion 21f of each of the frame materials 21A, 21B, 21C, and 21D which configures the frame 20. In other words, the cushion material 13 is provided to cover the core material 15 and the frame 20.

The cushion material 13 is formed of material having flexibility and elasticity, for example, a urethane foam material.

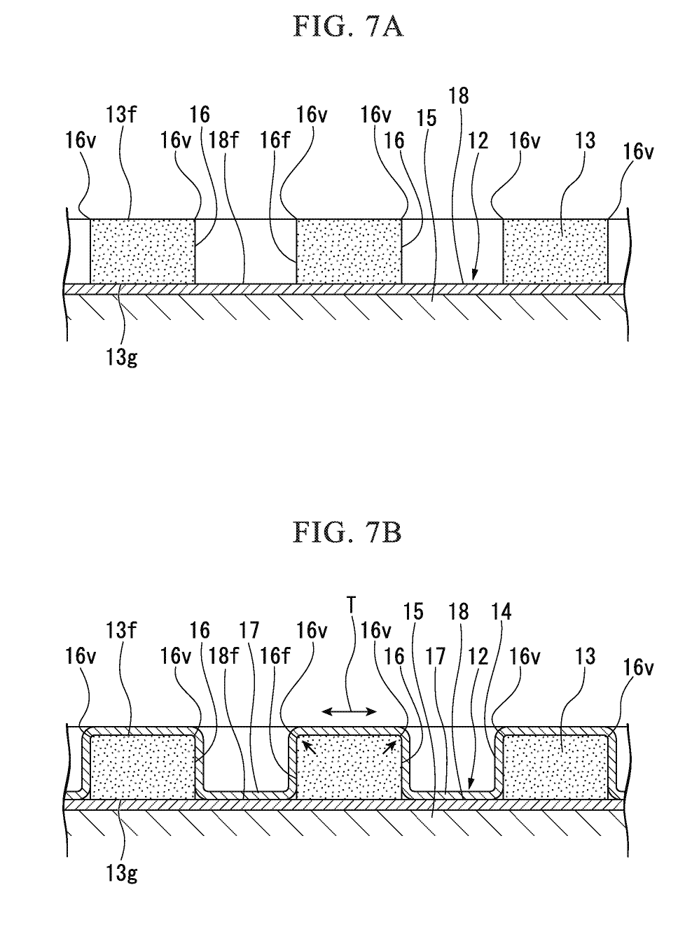

FIGS. 7A and 7B are sectional views showing the cushion material 13 which is provided along the surface of the panel base material 12. FIG. 7A is a sectional view of the cushion material 13 in a state where the cover material 14 is not mounted. FIG. 7B is a sectional view of the cushion material 13 in a state where the cover material 14 is mounted.

As shown in FIG. 2, a plurality of through holes 16 are farmed in the cushion material 13. The through hole 16 has, for example, an oval shape having the vertical direction as a long axial direction. On an outer surface 13f of the cushion material 13, the plurality of through holes 16 are arranged at intervals in the vertical direction and in the horizontal direction which is orthogonal to the vertical direction.

As shown in FIGS. 5, 7A, and 7B, each through hole 16 is formed to penetrate in the thickness direction of the cushion material 13 to an opposing surface 13g which opposes the panel base material 12 side from the outer surface 13f which is oriented to a side opposite to the panel base material 12 in the cushion material 13. As shown in FIG. 7A, in each through hole 16, an inner circumferential surface 16f is formed to be orthogonal to the outer surface 13f. Accordingly, an angle portion 16v is formed on a circumferential edge of the through hole 16.

As the cushion material 13 in which the through hole 16 is formed is provided on the surface of the panel base material 12, an uneven shape having the angle portion 16v is formed on the surface of the panel base material 12.

(Cover Material)

As shown in FIGS. 5 and 7B, the cover material 14 is provided to cover the entire cushion material 13. The cover material 14 is adhered along the outer surface 13f of the cushion material 13, the inner circumferential surface 16f which is orthogonal to the outer surface 13f in the through hole 16, and an exposed surface 18f of the base sheet 18 which is exposed in a bottom portion of the through hole 16. In this manner, as the cover material 14 is along the plurality of through holes 16 formed in the cushion material 13, a plurality of oval recessed portions 17 are formed on the surface of the panel body . In each recessed portion 17, the cover material 14 is adhered to the base sheet 18 which forms the surface of the panel base material 12 through the through hole 16.

Here, the cover material 14 is formed of an elastically deformable material, such as polyester, and covers the cushion material 13 and the panel base material 12 in an stretched state. In the cushion material 13, the angle portion 16v which is projected to the outside at the circumferential edge of the through hole 16 on the outer surface 13f side is pressed to the inside by the cover material 14. Accordingly, the cushion material 13 is elastically deformed in the direction of compression in the angle portion 16v, and the angle portion 16v of the through hole 16 becomes an arc-shaped section.

As shown in FIGS. 5 and 6, the cushion material 13 and the cover material 14 have an outer dimension which is greater than that of the panel base material 12. In the cushion material 13 and the cover material 14, outer circumferential end portions 13e and 14e go around an outer circumferential edge portion of the panel base material 12, that is, the side wall portion 21f of each of the frame materials 21A, 21B, 21C, and 21D, and are caught in the groove 25. At a part where the outer circumferential end portions 13e and 14e of the cushion material 13 and the cover material 14 go around the side wall portion 21f of each of the frame materials 21A, 21B, 21C, and 21D, the cushion material 13 is compressed by the cover material 14. Accordingly, the panel body 11 is formed so that the thickness thereof gradually becomes smaller when approaching an outer circumferential end portion 11s. The panel body 11 is formed in a circular arc shape at a part where the cushion material 13 and the cover material 14 go around the side wall portion 21f of each of the frame materials 21A, 21B, 21C, and 21D in the outer circumferential end portion 11s.

The cushion material 13 and the cover material 14 configure the cover structure.

(Fixing Member)

The fixing member 30 is fitted to the groove 25. The fixing member 30 nips the outer circumferential end portions 13e and 14e of the cushion material 13 and the cover material 14 which are caught in the groove 25 between the inner circumferential surface of the groove 25 and the outer circumferential surface of the fixing member 30. Accordingly, the outer circumferential end portions 13e and 14e of the cushion material 13 and the cover material 14 are fixed to the side wall portion 21f of the frame 20.

As shown in FIG. 2, the fixing member 30 includes a straight line portion fixing member 30S which is disposed at a straight line part 12S of the outer circumferential portion of the rectangular panel base material 12, and a corner portion fixing member 30C which is disposed in a corner portion 12C of the outer circumferential portion of the rectangular panel base material 12.

As shown in FIG. 5, the straight line portion fixing member 30S includes side part plate portions 31 and 31 which are disposed parallel to each other, and a linking plate portion 32 which integrally links the side part plate portions 31 and 31, in a sectional shape which is orthogonal to the direction in which the straight line portion fixing member 30S is continuous.

The side part plate portions 31 and 31 nip the outer circumferential end portions 13e and 14e of the cushion material 13 and the cover material 14 between the side part plate portions 31 and 31 and the side wall portion 21f which forms the groove 25 of the frame 20. Therefore, the interval between the side part plate portions 31 and 31 is formed to be smaller than the interval between the side wall portions 21 land 21f of the groove 25 by a predetermined dimension. When the straight line portion fixing member 30S is fitted into the groove 25, the side part plate portions 31 and 31 are formed so that tip end portions 31a and 31a abut against the base portion 21e of the groove 25.

The linking plate portion 32 is formed to be more offset in the direction of being separated from the base portion 21e of the groove 25 than the tip end portions 31a and 31a of the side part plate portions 31 and 31. Accordingly, the straight line portion fixing member 30S becomes a substantially H-shaped section by the side part plate portions 31 and 31 and the linking plate portion 32. A space S1 is formed at a part which is surrounded by the tip end portions 31a and 31a sides of the side part plate portions 31 and 31, the linking plate portion 32, and the base portion 21e of the groove 25, in a state where the straight line portion fixing member 30S is fitted into the groove 25. The space S1 functions as an accommodation space which can accommodate a residual portion of the outer circumferential end portions 13e and 14e of the cushion material 13 and the cover material 14 which are caught in the groove 25, that is, a more tip end part (not shown) than the part which abuts against the base portion 21e of the frame 20 among the outer circumferential end portions 13e and 14e.

In addition, in the side part plate portions 31 and 31, projections 33 and 33 are formed on a side opposing the side wall portions 21f and 21f of the groove 25. The projections 33 and 33 bite into the outer circumferential end portions 13e and 14e of the cushion material 13 and the cover material 14 which are nipped between the side part plate portions 31 and 31 and the side wall portions 21f and 21f. Accordingly, the straight line portion fixing member 30S prevents the cushion material 13 and the cover material 14 from falling out of the groove 25.

Furthermore, in the side part plate portions 31 and 31, projection strips 34 and 34 which protrude toward the inside from the side part plate portions 31 and 31 are formed on a side of being further separated from the base portion 21e of the groove 25 than the linking plate portion 32. A holding groove 35 for mounting an optional member or the like is formed being surrounded by the projection strips 34 and 34, the side part plate portions 31 and 31, and the linking plate portion 32.

As shown in FIG. 3, the corner portion fixing member 30C which is disposed at a corner portion of the upper portion of the panel body 11 is formed of a first straight line-like portion 38A which extends in the vertical direction, and a second straight line-like portion 38B which is bent from an upper end of the first straight line-like portion 38A and extends in the horizontal direction, in a substantial L shape.

The first straight line-like portion 38A is fitted into the groove 25 in the upper end portion of the frame material 21A or the frame material 21B which extends in the vertical direction. The second straight line-like portion 38B is formed to continuous from one end of the first straight line-like portion 38A, and is fitted into the groove 25 in both end portions of the frame material 21C or the frame material 21D which extends in the horizontal direction.

As shown in FIG. 6, the first straight line-like portion 38A and the second straight line-like portion 38B include a side part plate portions 36 and 36 which are disposed parallel to each other, and a linking plate portion 37 which integrally links the side part plate portions 36 and 36, in a sectional shape which is orthogonal to the direction in which the first straight line-like portion 38A and the second straight line-like portion 38B are continuous to each other.

The side part plate portions 36 and 36 nip the outer circumferential end portions 13e and 14e of the cushion material 13 and the cover material 14 between the side wall portions 21f and 21f which form the groove 25 of the frame 20. Therefore, the interval between the side part plate portions 36 and 36 is formed to be smaller than the interval between the side wall portions 21f and 21f of the groove 25 by a predetermined dimension. When the corner portion fixing member 30C is fitted into the groove 25, the side part plate portions 36 and 36 are formed so that tip end portions 36a and 36a abut against the base portion 21e of the groove 25.

In the side part plate portions 36 and 36, projected portions 36t and 36t are formed on a side opposing the side wall portions 21f and 21f of the groove 25. The projected portions 36t and 36t nip the outer circumferential end portions 13e and 14e of the cushion material 13 and the cover material 14 between the side part plate portions 36 and 36 and the side wall portions 21f and 21f.

The linking plate portion 37 is formed to be more offset in the direction of being separated from the base portion 21e of the groove 25 than the tip end portions 36a and 36a of the side part plate portions 36 and 36. Accordingly, the corner portion fixing member 30C becomes a substantially H-shaped section by the side part plate portions 36 and 36 and the linking, plate portion 37. In a state where the straight line portion fixing member 30S is fitted into the groove 25, a space S2 is formed at a part which is surrounded by the tip end portions 36a and 36a sides of the side part plate portions 36 and 36, the linking plate portion 37, and the base portion 21e of the groove 25. The space S2 functions as an accommodation space which can accommodate a residual portion of the outer circumferential end portions 13e and 14e of the cushion material 13 and the cover material 14 which are caught in the groove 25, that is, a more tip end part (not illustrated) than the part which abuts against the base portion 21e of the frame 20 among the outer circumferential end portions 13e and 14e. The linking plate portion 37 is closer to the base portion 21e than the linking plate portion 32 in the straight line portion fixing member 30S, and the space S2 is formed to be smaller than the space S1.

As shown in FIG. 3, the corner portion fixing member 30C is fixed to the groove 25 by a corner cap 40. The corner cap 40 has to substantial L shape which is made of a first straight line-like portion 41A and a second straight line-like portion 41B which is continuous to one end of the first straight line-like portion 41A and extends being orthogonal to the first straight line-like portion 41A. As shown in FIG. 6, the first straight line-like portion 41A and the second straight line-like portion 41B are inserted between the side part plate portions 36 and 36 with respect to the first straight line-like portion 38A and the second straight line-like portion 38B of the corner portion fixing member 30C, and abuts against the linking plate portion 37.

As shown in FIG. 3, a projection piece 43 is formed to protrude downward in a lower end portion of the first straight line-like portion 41A. The projection piece 43 is inserted into the holding groove 35 (refer to FIG. 5) between the linking plate portion 32 and the projection strip 34, in the upper end portion of the straight line portion fixing member 30S.

As shown in FIG. 3, a bolt through hole 44 into which a bolt 45 is inserted is formed in the second straight line-like portion 41B. By the bolt 45 which is inserted into the bolt through hole 44, the corner cap 40, the corner portion fixing member 30C, the frame material 21C, and the second plate portion 22b of the bracket 22 are integrally fastened.

(Support Leg Body)

As shown in FIG. 3, in a corner portion of a lower portion of the above-described panel body 11, the support leg body 50 is provided as the corner portion fixing member 30C. The support leg body 50 makes the panel body 11 stand on a floor surface by being grounded on the floor surface.

The support leg body 50 integrally includes a lower part support portion 51 which is accommodated in the groove 25 of the lower part end portion of the frame 20, a side part support portion 52 which extends upward from one end of the lower part support portion 51, and is accommodated in the groove 25 of the lower end portion of the side portion of the frame 20, and a support leg portion 53 which extends further downward than the lower part support portion 51.

The lower part support portion 51 is fixed to abut against the base portion 21e which forms the bottom surface of the groove 25 of the lower end portion of the frame 20. The side part support portion 52 is fixed to abut against the base portion 21e which forms the bottom surface of the groove 25 of the side end portion of the frame 20.

In the lower part support portion 51 and the side part support portion 52, a bolt through hole 54 into which a bolt 48 is inserted is formed. The bolt 48 which is inserted into the bolt through hole 54 is screwed into a female screw hole portion 29 which is formed at a predetermined position of the base portion 21e of the groove 25. Accordingly the support leg body 50 is fixed to the panel body 11.

The support leg portion 53 extends further downward than the lower part support portion 51, and a height adjustment screw 49 can be screwed to the lower end portion thereof.

(Linking Structure of Panel Body)

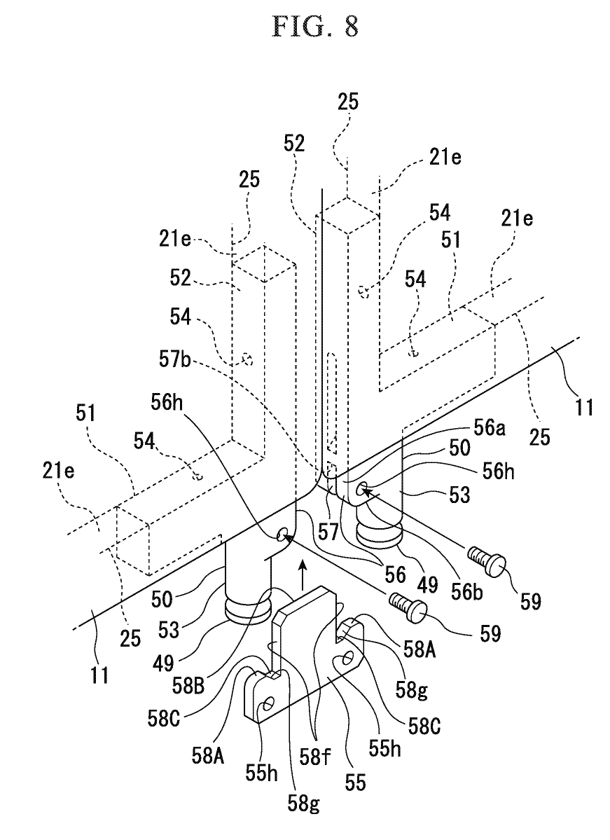

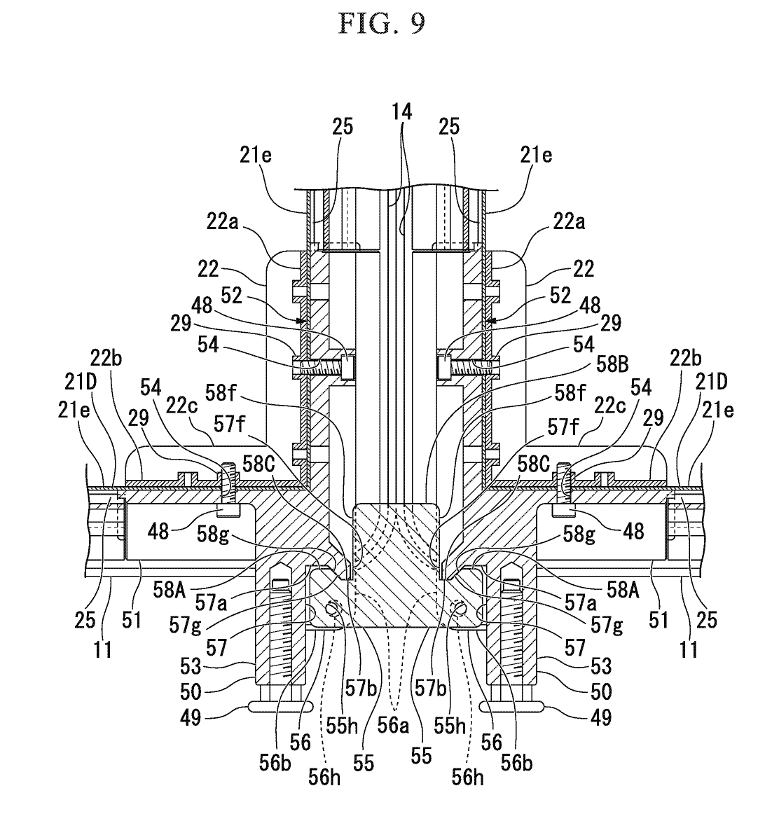

FIG. 8 is a perspective view showing the support leg body 50 provided in the angle portion of the lower portion of the panel body 11, and an example of a linking structure in the lower portion of the panel bodies 11 and 11 which are adjacent to each other. FIG. 9 is a sectional view illustrating a linking structure in the lower portion of the panel bodies 11 and 11 which are adjacent to each other.

As shown in FIGS. 8 and 9, one end of a linking member 55 for linking the support leg body 50 to the other panel body 11 which is disposed adjacent thereto, can be locked to the support leg body 50. Therefore, a bulged portion 56 which is bulged further downward than the lower part support portion 51 is integrally formed in the support leg body 50.

In the bulged portion 56, a slit 57 into which one end of the plate-like linking member 55 can be inserted is formed in the intermediate portion of the support leg body 50 which is along the thickness direction of the panel body 11. The slit 57 is opened to a side surface 56a and a lower surface 56b on a side adjacent to the other panel body 11 in the bulged portion 56.

As shown in FIG. 9, in an upper portion of the slit 57, an insertion recessed portion 57a into which a projection portion 58A of the linking member 55 which will be described later is inserted, is formed to be recessed upward. In the upper portion of the slit 57, on the side surface 56a side of the bulged portion 56, a projection portion 57b which is adjacent to the insertion recessed portion 57a and protrudes downward, is formed.

In the bulged portion 56, a locking hole 56h for locking the linking member 55 which is inserted into the slit 57 is formed to penetrate along the thickness direction of the panel body 11.

In both end portions of the linking member 55, through holes 55h are respectively formed. In both end portions of the linking member 55, the projection portions 58A which protrude upward are respectively formed. In the linking member 55, a center projection portion 58B which protrudes upward is formed between the projection portions 58A and 58A of both end portions. An engagement recessed portion 58C which is recessed downward is formed between the center projection portion 58B and the projection portion 58A on both sides of the center projection portion 58B.

In the projection portion 57b and the engagement recessed portion 58C, the side surface 56a side of the bulged portion 56 and the center projection portion 58B side are perpendicular surfaces 57f and 58f which extend in the vertical direction, and the sides opposite thereto are inclination surfaces 57g and 58g which are separated from the perpendicular surfaces 57f and 58f when approaching the upper part. Accordingly, the projection portion 57b and the engagement recessed portion 58C have a tapered shape of which a width dimension thereof gradually becomes smaller when approaching the lower part of any of the projection portion 57b and the engagement recessed portion 58C.

As the projection portion 57b of the slit 57 is fitted to the engagement recessed portion 58C, the linking member 55 and the support leg body 50 can be easily positioned in the direction in which the panel bodies 11 and 11 are adjacent to each other.

In order to link the panel bodies 11 and 11 which adjacent to each other, both end portions of the linking member 55 in which the through hole 55h is formed is inserted into the slit 57 of the support leg body 50. The projection portions 57b of the support leg body 50 provided in the panel bodies 11 on both sides are respectively fitted to the engagement recessed portions 58C of both end portions of the linking member 55. The projection portion 57b and the engagement recessed portion 58C have a tapered shape of which the width dimension gradually becomes smaller when approaching the lower part of any of the projection portion 57b and the engagement recessed portion 58C. Therefore, as the projection portion 57b is inserted into the engagement recessed portion 58C, the linking member 55 and the support leg body 50 are respectively positioned in the direction in which the panel bodies 11 and 11 are adjacent to each other. Accordingly, the through hole 55h of the both end portions formed in the linking member 55, and the locking hole 56h of the support leg body 50, communicate each other. A linking bolt 59 is inserted and fastened to the through hole 55h and the locking hole 56h. Accordingly, the panel bodies 11 and 11 which are adjacent to each other are linked in the lower end portion by the linking member 55.

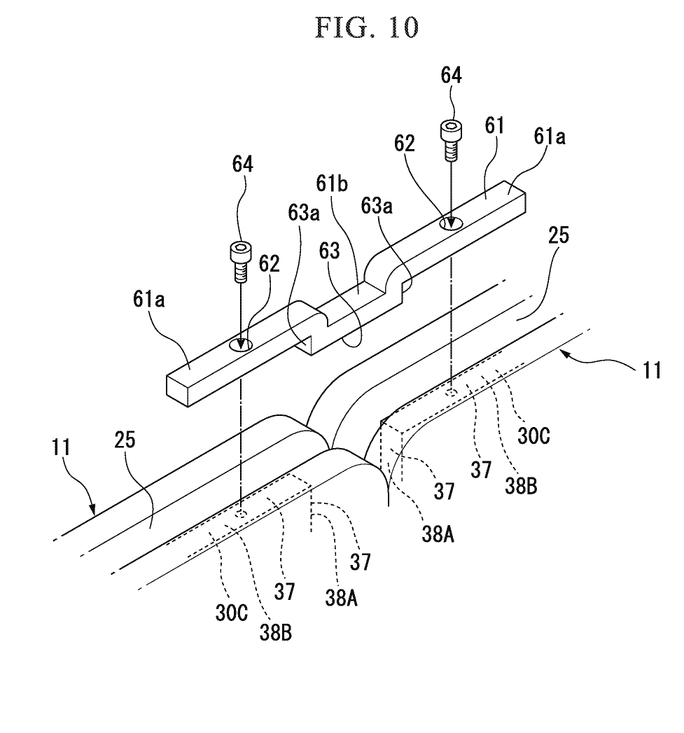

FIG. 10 is a perspective view showing an example of a linking structure in the upper portions of the panel bodies 11 and 11 which are adjacent to ach other.

As shown in FIG. 10, the panel bodies 11 and 11 which are adjacent to each other can respectively link the upper end portions thereof by an upper part linking member 61.

Instead of the corner cap 40, the upper part linking member 61 is attached to the corner portion fixing member 30C. A bolt through hole 62 is formed in both end portions 61a and 61a of the upper part linking member 61.

On the lower surface side of an intermediate portion 61b of the upper part linking member 61, an interval regulation portion 63 which regulates the interval of the corner portion fixing members 30C and 30C which are disposed on the upper portions of the panel bodies 11 and 11 which are adjacent to each other, is formed to protrude downward. As the interval regulation portion 63 is inserted between the corner portion fixing members 30C and 30C which are disposed in the upper portions of the panel bodies 11 and 11 which are adjacent to each other, it is possible to regulate the interval between the panel bodies 11 and 11 which are adjacent to each other.

The upper end portions of the panel bodies 11 and 11 which are adjacent to each other are linked by the upper part linking member 61 as follows.

First, the upper part linking member 61 is loaded onto the corner portion fixing members 30C and 30C which are disposed in the upper portions of the panel bodies 11 and 11 which are adjacent to each other. At this time, the lower surfaces of both end portions 61a and 61a of the upper part linking member 61 are inserted between the side part plate portions 36 and 36, and abut against the linking plate portion 37, with respect to the second straight line-like portion 38B of the corner portion fixing member 30C. As the interval regulation portion 63 is inserted between the corner portion fixing members 30C and 30C which are disposed in the upper portions of the panel bodies 11 and 11 which are adjacent to each other, it is possible to regulate the interval between the panel bodies 11 and 11 which are adjacent to each other.

More specifically, as both side surfaces 63a and 63a of the interval regulation portion 63 abut against the linking, plate portion 37 of the first straight line-like portion 38A of the corner portion fixing member 30C, it is possible to appropriately position the interval between the panel bodies 11 and 11 which are adjacent to each other. In this state, the upper part linking member 61, the corner portion fixing member 30C, the frame material 21C (refer to FIG. 3), and the second plate portion 22b (refer to FIG. 3) of the bracket 22, are integrally fastened by a bolt 64 which is inserted into the bolt through hole 62. Accordingly, the upper end portions of the panel bodies 11 and 11 which are adjacent to each other are linked.

(Manufacturing Method)

Next, a manufacturing method of the above-described panel body 11 will be described.

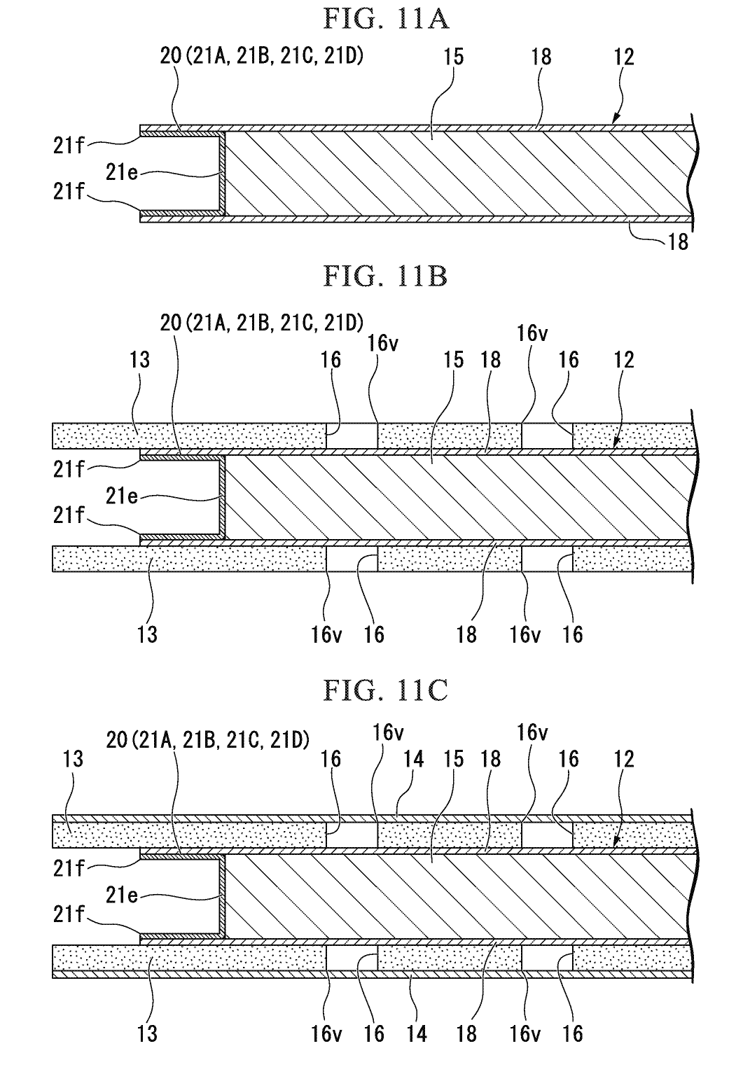

FIGS. 11A to 11C are views showing a flow of the manufacturing method of the panel body 11. FIG. 11A is a sectional view of a state where the panel base material 12 is assembled. FIG. 11B is a sectional view of a state where the cushion material 13 is provided on the surface of the panel base material 12. FIG. 11C is a sectional view of a state where the cover material 14 matches the surface of the cushion material 13.

(Panel Base Material Assembly Process)

First, as shown in FIG. 11A, the frame 20 having a predetermined shape is assembled.

Next, the base sheet 18 is adhered to one surface side (for example, a lower side in FIG. 11A) of the frame 20. In addition, the frame 20 is placed so that the side (one surface side) to which the base sheet 18 is adhered is oriented to downward. Next, the panel-like core material 15 is put into the frame 20, and is adhered to the lower base sheet 18. Next, the base sheet 18 is adhered to the other surface side (for example, the upper side in FIG. 11A) of the frame 20 which is oriented to upward. Accordingly, the panel base material 12 which is formed of the core material 15, the frame 20, and the base sheet 18 is configured.

(Cushion Material Pasting Process)

Next, as shown in FIG. 11B, on both surface sides of the panel base material 12, the cushion materials 13 in which the plurality of through holes 16 having the angle portion 16v at the circumferential edge are formed in advance, are respectively adhered to the base sheet 18. Accordingly, the uneven shape is formed on the surface of the panel base material 12 by the cushion material 13.

(Cover Material Disposing. Process)

Next, as shown in FIG. 11C, the cover material 14 is disposed along the cushion material 13 to cover the cushion material 13. At this time, the adhesive is respectively coated on the cushion material 13 and the cover material 14.

(Recessed Portion Forming Process)

By pressing the material of the panel body 11 which is in a state of FIG. 11C by a press mold, the cover material 14 is formed along the uneven shape by the cushion material 13. Accordingly, the cover material 14 is tightly adhered in accordance with the shape of the cushion material 13. As a result, the cover material 14 is adhered to match the outer surface 13f of the cushion material 13, the inner circumferential surface 16f which is orthogonal to the outer surface 13f in the through hole 16, and the exposed surface 18f of the base sheet 18 which is exposed in a bottom portion of the through hole 16. Accordingly, as described in FIG. 7B, in the cover material 14, a plurality of oval recessed portions 17 are formed on the surface of the panel body 11 along the uneven shape which is made of the plurality of through holes 16 formed in the cushion material 13.

In this manner, as a result of making the cover material 14 adhered, in the cushion material 13, the angle portion 16v which is projected to the outside at the circumferential edge of the through hole 16 on the outer surface 13f side is pressed to the inner side by the cover material 14. Accordingly, the cushion material 13 is elastically deformed in the direction of compression in the angle portion 16v, and the angle portion 16v of the through hole 16 becomes an arc-shaped section.

(Fixing Member Mounting Process)

Next, as shown in FIGS. 5 and 6, the outer circumferential end portions 13e and 14e of the cushion material 13 and the cover material 14 which become wider to the outer circumferential side than the outer circumferential edge portion of the frame 20, go around the outer circumferential edge portion of the panel base material 12, and are caught in the groove 25.

In addition, the straight line portion fixing member 30S, the corner portion fixing member 30C, and the support leg body 50 which configure the fixing member 30, are fitted and fixed to the groove 25.

Accordingly, the panel body 11 is completed.

The cover structure of the above-described panel body 11 and the panel body 11 are provided at at least a part of the surface of the panel base material 12, form the uneven shape having the angle portion 16v on the surface of the panel base material 12, and include the cushion material 13 having elasticity and the cover material 14 which elastically deforms the angle portion 16v in the direction of compression and covers the cushion material 13 and the panel base material 12.

In the cover structure, as the cover material 14 matches the uneven shape formed on the surface of the panel base material 12 by the cushion material 13, the recessed portion 17 is formed at a part covered by the cover material 14.

In the formed recessed portion 17, the angle portion 16v of the cushion material 13 is elastically deformed in the direction of compression by the cover material 14. Therefore, the cover material 14 is pressed by the repulsive force of the angle portion 16v at a part which abuts against the angle portion 16v. Therefore, the shape of the recessed portion 17 is maintained, and the cover material 14 extends in the direction shown by an arrow T in FIG. 7B in the direction along the outer surface 13f of the cushion material 13, and can prevent the cover material 14 from becoming loose.

In this manner, it is possible to provide the panel body 11 having excellent design at a low cost.

In the cushion material 13, the through hole 16 having the angle portion 16v at the circumferential edge is formed.

Accordingly, it is possible to form the uneven shape on the surface of the panel base material 12.

If the size of the cushion material 13 is smaller than the size of the surface of the panel base material 12, it is possible to form the uneven shape on the surface of the panel base material 12 by the angle portion 16v in the outer circumferential edge portion of the cushion material 13. In this case, in order to form the uneven shape according to the design, it is necessary that the cushion material 13 is accurately positioned on the surface of the panel base material 12. Meanwhile, when the through hole 16 is formed in the cushion material 13, only by disposing, the cushion material 13 along the surface of the panel base material 12, it is possible to accurately realize file uneven shape. Accordingly, the degree of freedom of design of the uneven shape is improved.

In the cushion material 13, the through hole 16 having the angle portion 16v on the circumferential edge is formed. The cover material 14 is directly adhered to the exposed surface 18f of the base sheet 18 which is on the surface of the panel base material 12 through the through hole 16.

Accordingly, compared to a case where the uneven shape is formed by the recessed portion which does not penetrate the cushion material 13, in the recessed portion 17 formed at the part covered by the cover material 14, the step becomes large, dynamic, and the design is improved.

The cushion material 13 is generally formed of a sponge-like porous material of the like.

In this case, it is difficult to ensure the adhering strength since the contact area between the cushion material 13 and the cover material 14 is small. Meanwhile, since the cover material 14 is directly adhered to the surface of the panel base material 12 on the inner side of the through hole 16, the cover material 14 and the cushion material 13 are adhered so as to form a surface. Therefore, compared to the part where the cover material 14 is adhered to the cushion material 13, the cover material 14 is firmly adhered. Accordingly, it is possible to prevent the cover material 14 from being peeled as time elapses, and to stably maintain the shape over a long period of time.

Furthermore, the cover material 14 is formed of an elastically deformable material, and covers the cushion material 13 and the panel base material 12 in an stretched state.

Accordingly, the cover material 14 stretches, and the design is improved.

Here, the panel base material 12 includes the core material 15 having the honeycomb structure, and sheet materials which are provided on both surfaces of the core material 15. Accordingly, the panel base material 12 has sufficient strength while being light in weight.

In addition, the above-described manufacturing method of the panel body 11 includes a process of pasting the cushion material 13 onto the surface of the panel base material 12; a process of disposing the cover material 14 to cover the panel base material 12 and the cushion material 13; and a process of matching the over material 14 to the uneven shape by pressing the cover material 14 against the cushion material 13, and elastically deforming the angle portion 16v of the cushion material 13 in the direction of compression by the cover material 14. Accordingly, it is possible to manufacture the above-described panel body 11.

(Other Embodiments)

The present invention is not limited to each of the above-described embodiments described with reference to the drawings, and various modification examples are considered within a technical range.

For example, in the above-described embodiments, the groove 25 is formed across the entire outer circumferential portion of the panel base material 12, but the invention is not limited thereto. The groove 25 may be provided at at least a part of the outer circumferential portion of the panel base material 12, and at least the cover material 14 may be caught in the groove 25. For example, the bottom portion or the like of the panel base material 12 may not be provided with the groove 25, and may press and fix the outer circumferential end portion 14e of the cover material 14 by a general frame or the like.

In addition, as an example of fixing means which fixes the cover material 14 in the groove 25, the fixing member 30 is described. However, if the cover material 14 can be fixed, any configuration element may be employed. For example, the sectional shape or the structure of the fixing member 30 is not particularly limited. Furthermore, the cover material 14 may be fixed to the inside of the groove 25 by tacking or by adhering.

Furthermore, in the above-described embodiment, the panel base material 12 is formed of the core material 15, the frame 20, and the base sheet 18, but the invention is not limited thereto. For example, if the required strength can be ensured by a single body, for example, the panel which is made of a resin material or the like may be used as the panel base material 12, and the groove 25 may be formed on the outer circumferential portion. The base material can be made of a member or the like which configures the outer surface of various types of furniture. Accordingly, the surface of the furniture can be formed of an uneven portion, and the design can be improved.

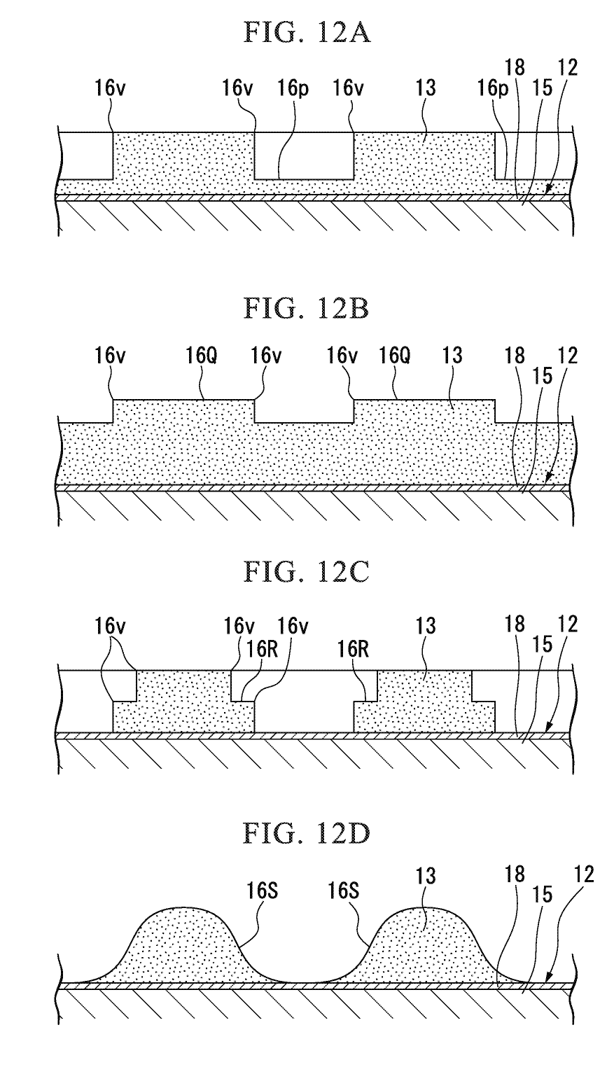

In the above-described embodiment, the through bole 16 is formed in the cushion material 13 for forming the uneven shape on the surface of the panel base material 12, but the invention is not limited thereto. For example, as shown in FIGS. 12A to 12C, in the cushion material 13, a non-penetrating recessed portion 16P (refer to FIG. 12A), a projected portion 16Q (refer to FIG. 12B), and a step portion 16R (refer to FIG. 12C) or the like may be formed. Furthermore, the sectional shape of the uneven shape may also be any shape, and for example, as shown in FIG. 12D, a curved projected portion 16S or the like may be employed.

In the above-described embodiment, the through hole 16 which forms the uneven shape is, for example, an oval shape having the vertical direction as the long axial direction. However, other than the oval shape, a circular shape or a polygonal shape, or other shapes, such as company logo, may be employed.

Furthermore, in the above-described embodiment, as the inner circumferential surface 16f is orthogonal to the outer surface 13 f, the through hole 16 forms the angle portion 16v in the outer circumferential edge portion. However, the inner circumferential surface 16f and the outer surface 13f may be inclined and intersect each other.

In addition, in the above-described embodiment, the outer circumferential end portions 13e and 14e of the cushion material 13 and the cover material 14 go around the side wall portion 21f of each of the frame materials 21A, 21B, 21C, and 21D which configures the panel base material 12, and are caught in the groove 25. However, by making the cushion material 13 smaller than the outer circumferential dimension of the panel base material 12, only the cover material 14 may be caught in the groove 25.

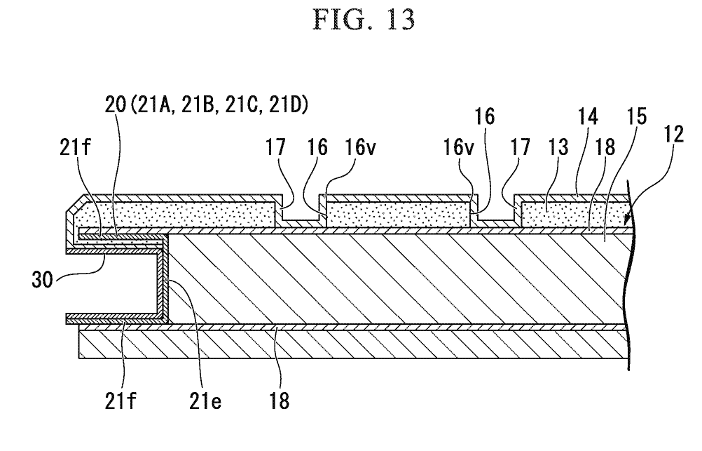

Furthermore, the cover structure described in the above-described embodiment is not limited to being, formed on both surfaces of the panel base material 12, and as shown in FIG. 13, the cover structure may be formed only one surface side of the panel base material 12.

In addition, in the above-described embodiment, the support leg body 50 is provided in the panel body 11, but if the panel body 11 is fixed to be furniture or the like by other brackets or the like, it is not necessary to provide the support leg body 50.

In the above-described embodiment, the partition equipment 10 is provided along the rear surface side of the sofa 100, but the invention is not limited thereto. The partition equipment 10 may be provided to be assembled to a desk, a table, a counter, shelves, or a chair, other than the sofa 100. Furthermore, the partition equipment 10 may be free-standing on the floor surface by the support leg body 50. In addition, the partition equipment 10 may be fixed and provided by the bracket or the like which is not illustrated, in construction, such as a wall or a column.

In addition to this, it is possible to select a configuration described in the above-described embodiments, or to appropriate change the configuration to other configurations without departing from the scope of the present invention.

### INDUSTRIAL APPLICABILITY

According to the present invention, it is possible to provide a panel body having excellent design at a low cost.

### REFERENCE SIGNS LIST

10 PARTITION EQUIPMENT

11 PANEL BODY

12 PANEL BASE MATERIAL (BASE MATERIAL)

13 CUSHION MATERIAL

13e, 14e OUTER CIRCUMFERENTIAL END PORTION

14 COVER MATERIAL

CORE. MATERIAL

15h HOLE

16f THROUGH HOLE

16v ANGLE PORTION

16f INNER CIRCUMFERENTIAL SURFACE

17 RECESSED PORTION

18 BASE SHEET (SHEET MATERIAL)

20 FRAME

25 GROOVE

30 FIXING MEMBER

30C CORNER PORTION FIXING MEMBER

30S STRAIGHT LINE PORTION FIXING MEMBER

50 SUPPORT LEG BODY

51 LOWER PART SUPPORT PORTION

52 SIDE PART SUPPORT PORTION

53 SUPPORT LEG PORTION

55 LINKING MEMBER

57 SLIT

61 UPPER PART LINKING MEMBER

100 SOFA

S1 SPACE

S2 SPACE

1. A cover structure comprising:
an elastic cushion material which is provided at at least a part of a surface of a base material, and forms an uneven shape having an angle portion on the surface of the base material; and
a cover material which elastically deforms the angle portion in the direction of compression, and covers the cushion material and the base material,
wherein at least one type of a through hole, a recessed portion, and a projected portion which have the angle portion on a circumferential edge is formed in the cushion material.

2. The cover structure according to claim 1,
wherein the through hole which has the angle portion on the circumferential edge is formed, and the uneven shape is formed by the through hole, in the cushion material, and
wherein the cover material is directly adhered to the surface of the base material through the through hole.

3. The cover structure according to claim 1,
wherein the cover material is formed of an elastically deformable material, and covers the cushion material and the base material in a stretched state.

4. A panel body comprising:
a panel-shaped base material in which the cover structure according to claim 1 is formed.

5. The panel body according to claim 4,
wherein the base material includes a core material of a honeycomb structure which has multiple holes which penetrate the base material in the thickness direction, and a sheet material which is provided along both surfaces of the core material.

6. A panel body manufacturing method of the panel body according to claim 4, the method comprising:
a process of pasting the cushion material onto a surface of the base material;
a process of disposing the cover material to cover the base material and the cushion material; and
a process of matching the cover material to the uneven shape by pressing the cover material against the cushion material, and elastically deforming the angle portion of the cushion material in the direction of compression by the cover material.

7. The cover structure according to claim 2,
wherein the cover material is formed of an elastically deformable material, and covers the cushion material and the base material in a stretched state.

8. A panel body comprising:
a panel-shaped base material in which the cover structure according to claim 2 is formed.

9. A panel body manufacturing method of the panel body according to claim 5, the method comprising:
a process of pasting the cushion material onto a surface of the base material;
a process of disposing the cover material to cover the base material and the cushion material; and
a process of matching the cover material to the uneven shape by pressing the cover material against the cushion material, and elastically deforming the angle portion of the cushion material in the direction of compression by the cover material.

10. A panel body comprising:
a panel-shaped base material in which the cover structure according to claim 3 is formed.
